(19) United States
(12) Patent Application Publication
(10) Pub. No.: US 2003/0218641 A1
(43) Pub. Date: Nov. 27, 2003

(54) Method and system for navigating a hierarchical structure in a data processing system

(75) Inventor: Giuseppe Longobardi, Roma (IT)

Correspondence Address: Jeff S. Labaw, International Business Machines, Intellectual Property Law, 11400 Burnet Road, Austin, TX, 78758, US

(73) Assignee: INTERNATIONAL BUSINESS MACHINES CORPORATION, Armonk, NY

(21) Appl. No.: 10/401,335

(22) Filed: Mar. 27, 2003

(30) Foreign Application Priority Data
May 23, 2002 (EP) 02368052.3

(51) Int. Cl. G09G 5/00

(52) U.S. Cl. 345/853

(57) ABSTRACT

A method and a corresponding system for navigating a hierarchical structure (such as a file system) in a data processing system are proposed. Typically, the file system is organized as a tree; each node of the tree is represented by a corresponding graphical object (232). Whenever the user selects the object representing a node having one or more child nodes dependent thereon, the selected object is expanded displaying the objects representing the corresponding child nodes. In the method of the invention, all the objects interposed between the object representing the selected node and the object representing its parent node are condensed into a single object (330) or are hidden; alternatively, the object representing the selected node is moved close to the object representing its parent node (rearranging the objects representing its sibling nodes). The proposed solution provides an enhanced perception of the hierarchical structure of the file system, and particularly of the path from a root node to a target node.

### TECHNICAL FIELD

The present invention relates to the information technology field, and more specifically to a method and system for navigating a hierarchical structure in a data processing system.

### BACKGROUND ART

Modern data processing systems (for example, Personal Computers) are provided with a Graphical User Interface (GUI). This interface allows a user to control programs running on the computer through stylized graphical elements, such as windows, dialog boxes, and pop-up or pull-down menus.

The graphical user interface makes it possible to display and manage a wide variety of information. For example, the graphical user interface is well suited for navigating a hierarchical structure, such as a file system of the computer. The file system is typically organized as a tree; a target node of the tree is identified by a path starting from a root node and reaching the target node through every interposed node (if any).

Each node is represented by a corresponding graphical object (such as a folder). Whenever the user selects the object representing a node having one or more child nodes dependent thereon, the selected object is expanded displaying the objects representing the corresponding child nodes. One of these objects may be selected and expanded in turn, and so on until the target node is reached.

A drawback of the graphical user interfaces known in the art is that the resulting visual representation of the hierarchical structure is quite confusing. In fact, when the user reaches the target node the corresponding path from the root node generally does not fit in a window displaying the hierarchical structure. Therefore, only a portion of the relevant information is shown at any one time, forcing the user to scroll the path through the window.

As a consequence, perception of the hierarchical structure is extremely difficult. Moreover, navigating the hierarchical structure becomes quite tedious; particularly, several kinds of operations on the hierarchical structure (such as moving or copying a node) are very time-consuming.

These drawbacks are exacerbated when the hierarchical structure is large, with a high number of nested nodes that must be expanded in order to reach the target one.

### SUMMARY OF THE INVENTION

It is an object of the present invention to provide a method and a corresponding system for navigating a hierarchical structure in a data processing system, which method and system generate a visual representation of the hierarchical structure that is concise and ensures a good overview of the structure.

It is another object of the present invention to provide an enhanced perception of the hierarchical structure.

It is yet another object of the present invention to facilitate simple and clear navigation within the hierarchical structure, so as to allow fast and easy execution of several kinds of operations on the hierarchical structure.

The accomplishment of these and other related objects is achieved by a method of navigating a hierarchical structure in a data processing system, the hierarchical structure having a plurality of nodes, wherein the method includes the steps of: displaying a visual representation of at least part of the hierarchical structure, the visual representation including a tree of graphical objects each one representing a node, selecting a graphical object representing a selected node among a plurality of sibling nodes dependent on a common parent node, the selected node having at least one child node dependent thereon, expanding the selected graphical object by displaying the graphical objects representing the at least one child node, and updating the visual representation to have at most one graphical object interposed between the expanded graphical object and the graphical object representing the parent node.

The present invention also provides a computer program for performing the method, and a product storing the program. Furthermore, the invention provides a graphical user interface implementing the method, and a corresponding data processing system.

The novel features believed to be characteristic of this invention are set forth in the appended claims. The invention itself, however, as well as these and other related objects and advantages thereof, will be best understood by reference to the following detailed description to be read in conjunction with the accompanying drawings.

### BRIEF DESCRIPTION OF THE DRAWINGS

FIG. 1 is a pictorial representation of a computer in which the method of the invention can be used;

FIGS. 2a-2d depict a method of navigating a hierarchical structure according to the prior art;

FIGS. 3a-3e depict a method of navigating the same hierarchical structure according to a preferred embodiment of the present invention;

FIGS. 4a-4b, 5 show alternative embodiments of the invention;

FIG. 6 is a partial content of a working memory of the computer;

FIGS. 7a-7c show a flow chart describing the logic of a method for navigating the hierarchical structure.

### DETAILED DESCRIPTION OF THE PREFERRED EMBODIMENT

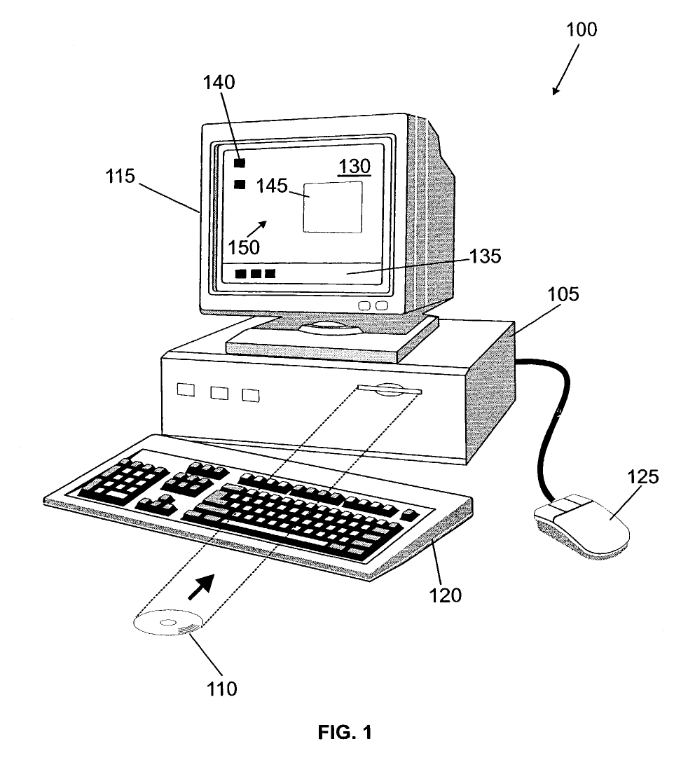

With reference in particular to FIG. 1, a Personal Computer 100 is shown. The computer 100 consists of a central unit 105, which houses the electronic circuits controlling its operation (such as a microprocessor and a working memory), in addition to a hard-disk and a driver for CD-ROMs 110. A monitor 115, a keyboard 120, and a mouse 125 (having a left and a right button) are connected to the central unit 105 in a conventional manner.

The computer 100 is provided with a graphical user interface. Particularly, a screen 130 of the monitor 115 is arranged to resemble a desktop; execution of programs on the computer 100 involves different types of graphical elements to be displayed on the desktop. In the example at issue, the desktop includes an application bar 135, two icons 140 and a window 145. A user interacts with the programs by generating a sequence of mouse and keyboard commands; a current position on the desktop, to which the mouse points, is denoted with an arrow 150.

Particularly, the window 145 runs an exploring tool for navigating a hierarchical structure, such as a file system of the computer 100. The file system is organized as a tree, starting from a root node defining a (physical or logical) device, also referred to as root directory. Each intermediate node (having one or more child nodes dependent thereon) is a sub-directory. Leaf nodes (having no child nodes dependent thereon) are either empty sub-directories or files. A target node of the tree (sub-directory or file) is identified by a path starting from the root directory and reaching the target node through the interposed sub-directories (if any). For example, a file called “FILE3” that is listed in sub-directory “DIR4.5.1” dependent on sub-directory “DIR4.5”, which in turn depends on sub-directory “DIR4” in root directory “C:”, is identified by the path “C:\DIR4\DIR4.5\DIR4.5.1\FILE3”.

Similar considerations apply if the computer has a different structure, is replaced in the with an equivalent data processing system, or includes different units (for example, a printer), if an equivalent output unit and an equivalent input unit are envisaged instead of the monitor and the mouse, respectively, if the computer supports a different user interface, if the window is used to navigate other hierarchical structures (such as web pages in the INTERNET or network resources), and the like.

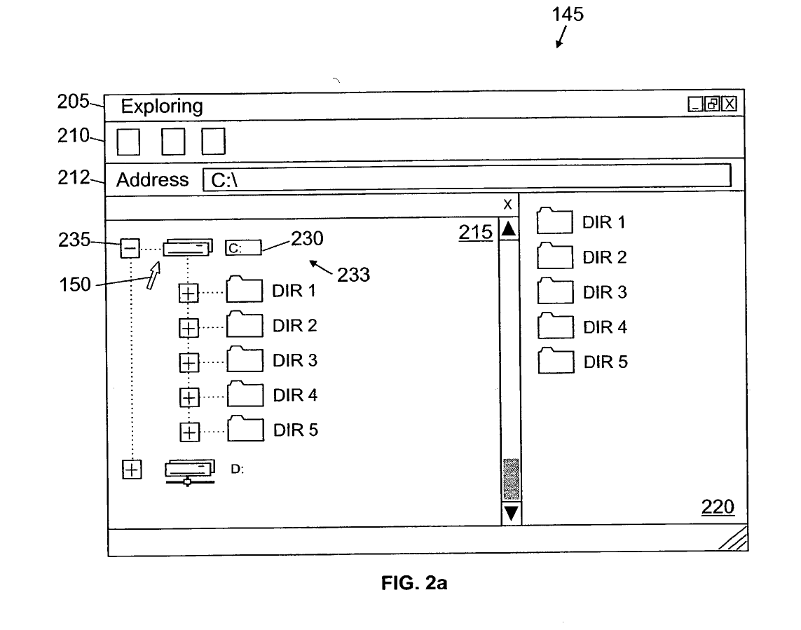

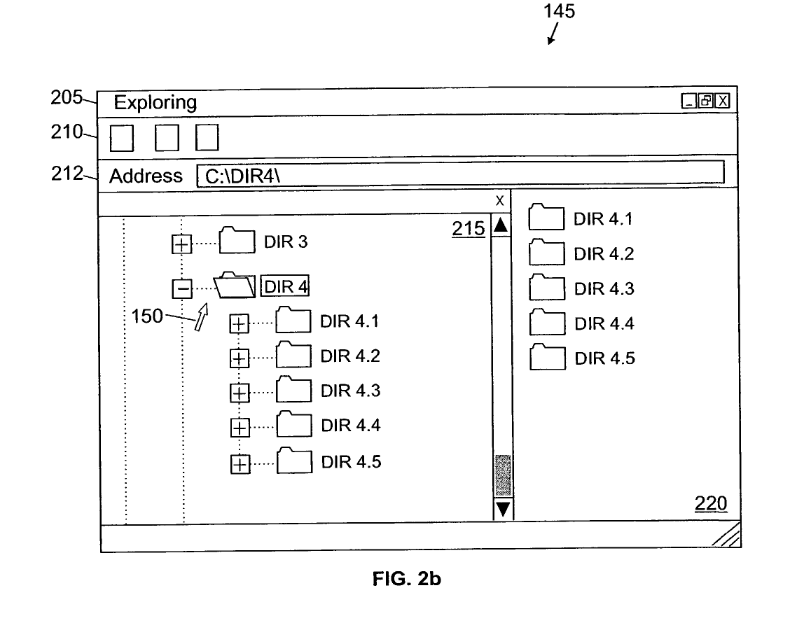

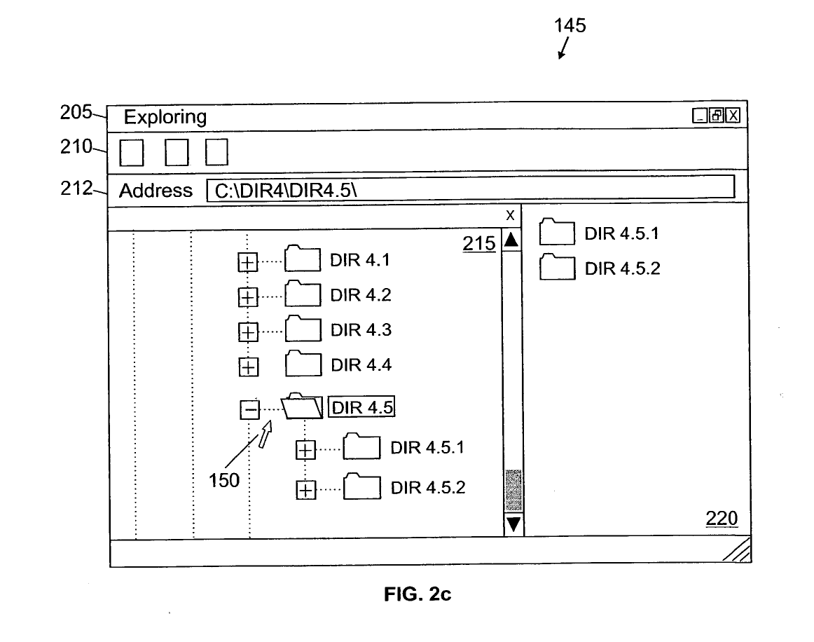

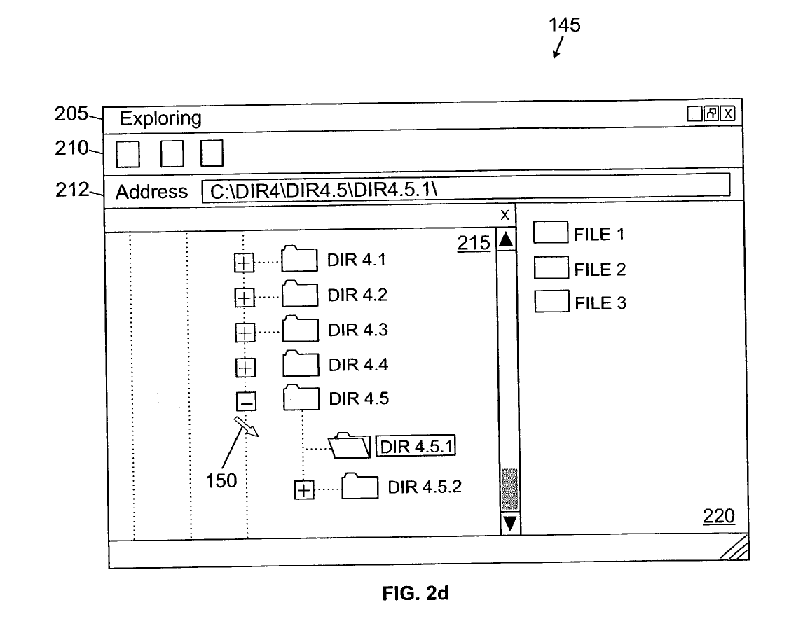

As shown in FIG. 2a, a title bar 205 at the top of the window 145 contains the name identifying the corresponding program (“Exploring”). A menu 210 with a series of push buttons for controlling the exploring window 145 is displayed below the title bar 205. An input box 212 is used to enter the path defining an address of a currently selected node. The active area of the exploring window 145 is split into two frames 215 and 220; the frame 215 displays a visual representation of the file system (or a portion thereof) and the frame 220 displays the content of the selected directory (root directory or sub-directory). Each node is represented by a graphical object 223. The object 223 consists of a stylized element 225, such as a memory device (for the root directory), a (closed) folder for a sub-directory, or a box for a file; the stylized element 225 is followed by a label 230 identifying the name of the node. A small box 235 at the left of the stylized element 225 is associated with each directory; the box 235 is filled with either the sign “+” when the object is collapsed (without displaying the objects representing its child nodes) or the sign “−” when the object is expanded (displaying the objects representing its child nodes); in the example shown in the figure (each object 223 is denoted with the name of the corresponding node of the file system in the following) the objects “DIR1”-“DIR5” and “D:” are collapsed, whereas the object “C:” is expanded. A node is selected clicking on the corresponding object 223. The label 230 of the selected node is highlighted; moreover, if the selected node represents a sub-directory the respective folder 225 is open; at the same time, the expansion box 235 (if any) is switched to the sign “−” and the objects representing the child nodes dependent on the selected node are displayed below the expanded object and in the frame 220.

In the example at issue, the file system has two root directories “C:” and “D:”; the root directory “C:” includes five sub-directories “DIR1”-“DIR5”. The root directory “C:” is selected by default when the exploring window 145 is opened. If the user now selects one of its sub-directories, such as the sub-directory “DIR4”, the corresponding object is expanded (see FIG. 2b). For example, the sub-directory “DIR4” includes five further sub-directories “DIR4.1”-“DIR4.5”. In order to accommodate all the objects “DIR4.1”-“DIR4.5” in the frame 215, its content is scrolled moving the object “DIR3” to the top (with the objects from “C:” to “DIR2” that disappear). The user in turn selects one of these sub-directories, such as the sub-directory “DIR4.5”. Moving to FIG. 2c, the corresponding object “DIR4.5” is likewise expanded displaying the objects representing the child nodes dependent thereon (for example, the sub-directories “DIR4.5.1” and “DIR4.5.2”). As a consequence, the frame 215 is further scrolled moving the object “DIR4.1” to the top (with the objects from “DIR2” to “DIR4” that disappear as well). Considering now FIG. 2d, if the user selects one of these sub-directories (such as the sub-directory “DIR4.5.1”) the files listed therein (for example, “FILE1”-“FILE3”) are displayed in the frame 220. The user can then select and open-a desired target file, such as the file “FILE3”. As shown in the figure, in a graphical user interface known in the art the representation of the path from the root directory “C:” to the target file “FILE3” (that is, “C:\DIR4\DIR4.5\DIR4.5.1\FILE3) is completely lost.

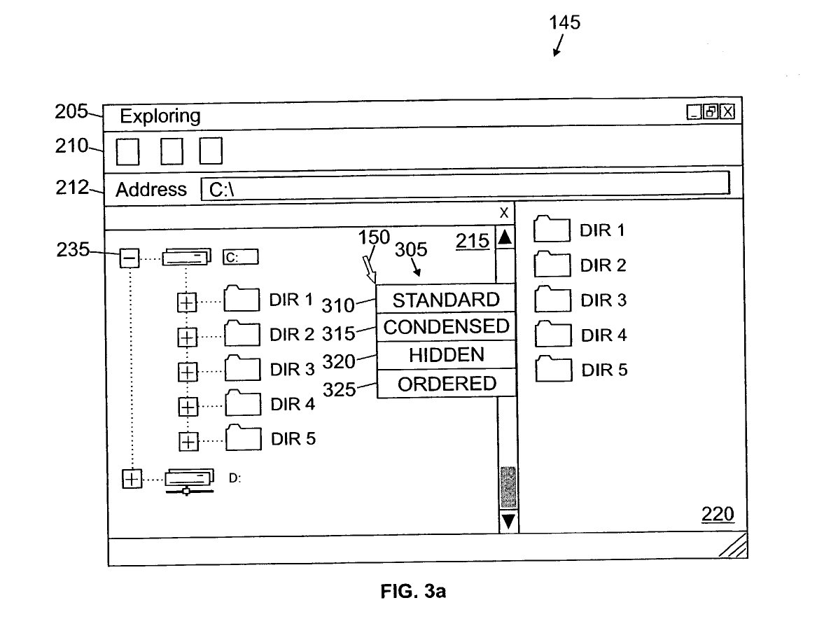

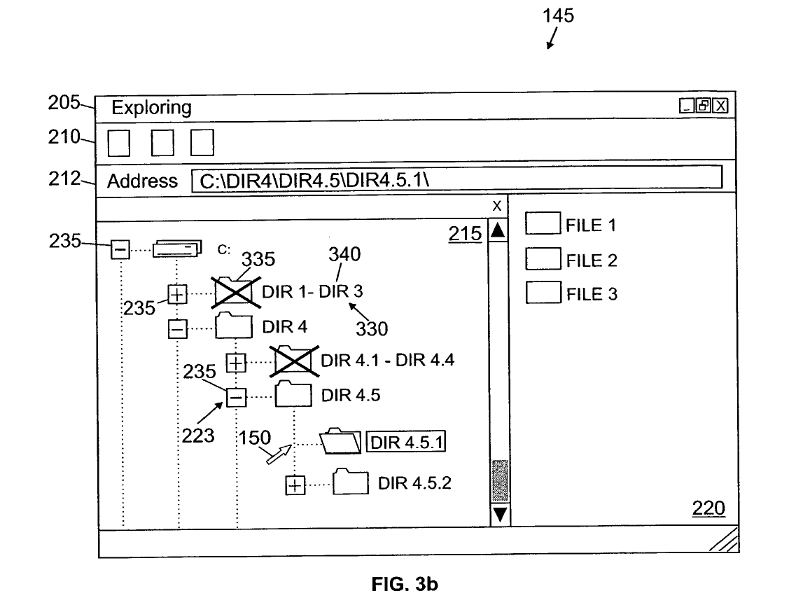

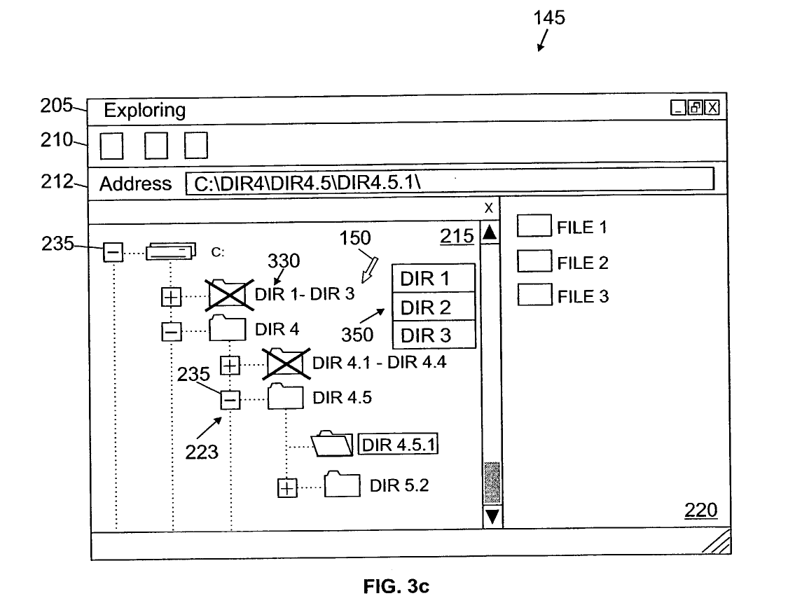

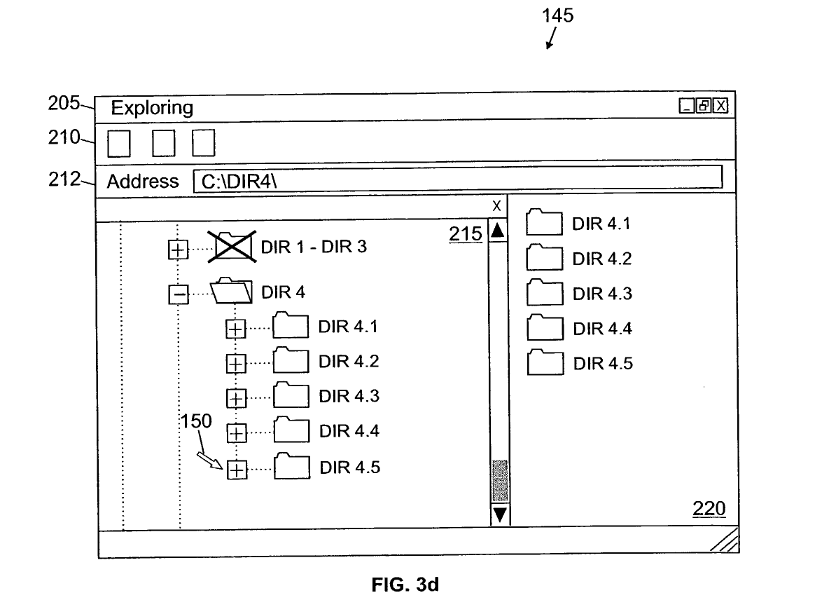

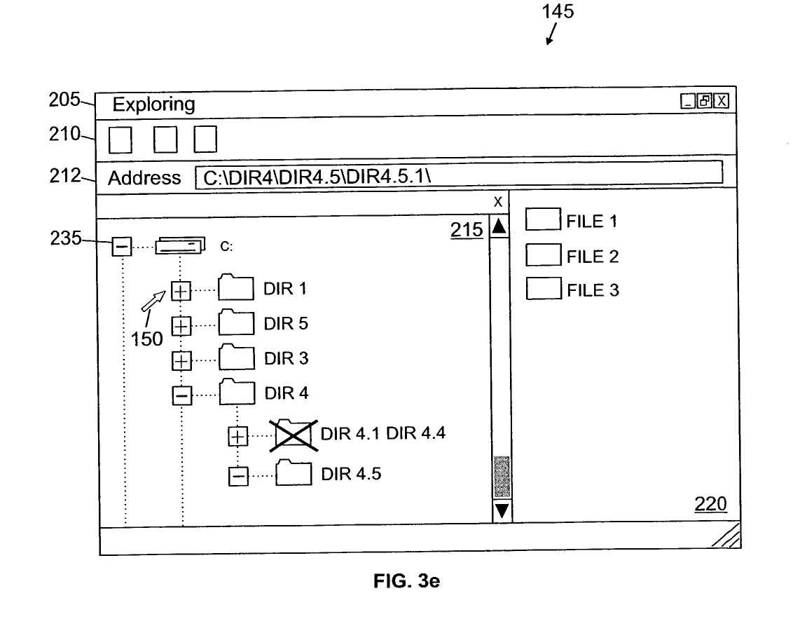

With reference now to FIG. 3a (the elements corresponding to the ones shown in FIG. 2a are denoted with the same references, and their explanation is omitted for the sake of simplicity), a graphical user interface implementing a preferred embodiment of the method according to the present invention is shown. In this case, a different visual representation of the file system is supported. In detail, the user points to a blank area of the window 145 and clicks the right button of the mouse. A pop-up menu 305 appears on the desktop, close to the pointer 150; the pop-up menu 305 includes a standard option 310 (corresponding to the representation shown in the FIGS. 2b-2d), a condensed option 315, a hidden option 320 and an ordered option 325 (described in the following).

If the user sets the condensed option 315, whenever a node is selected and expanded all the objects interposed between the one representing the selected node and the one representing its parent node are condensed into a single graphical object 330 (see FIG. 3b). The condensed object 330 consists of a crossed folder 335, having the respective expansion box 235 filled with the sign “+”. The crossed folder 335 is followed by a common label 340 identifying the nodes represented by the objects that have been condensed; preferably, the common label 340 is formed hyphenating the names of the first one and the last one of these nodes.

In the example shown in the figure (path “C:\DIR4\DIR4.5\DIR4.5.1\FILE3”), the objects from “DIR1” to “DIR3” are condensed into a single object identified by the common label “DIR1-DIR3”, and the objects from “DIR4.1” to “DIR4.4” are condensed into a single object identified by the common label “DIR4.1-DIR4.4”. As a consequence, the representation of the path from the root directory “C:” to the target file “FILE3” may be accommodated in the frame 215 entirely.

Moving to FIG. 3c, whenever the mouse is positioned over a condensed object 330 (without clicking any button) a pop-up window 350 appears on the desktop (close to the pointer 150); the pop-up window 350 includes a list of the names identifying the nodes associated with the condensed object 330. In the example shown in the figure, the user points to the condensed object “DIR1-DIR3”; the pop-up window 350 then shows the names “DIR1”, DIR2” and “DIR3”.

If the user now selects and collapses an expanded object 223 (by clicking on the respective expansion box 235), the objects representing the corresponding child nodes disappear; at the same time, the condensed object associated with the sibling nodes of the selected one is removed and the objects interposed between the collapsed object and the object representing the corresponding parent node are restored. For example, if the user collapses the object “DIR4.5”, the objects “DIR4.1”, “DIR4.2”, “DIR4.3” and “DIR4.4” are restored in place of the condensed object “DIR4.1-DIR4.4” (as shown in FIG. 3d).

Referring back to FIG. 3b, if the user selects a condensed object 330, the condensed object disappears and the objects representing the corresponding nodes are restored. For example, if the user selects the condensed object “DIR1-DIR3”, the objects “DIR1”, “DIR2” and “DIR3” are restored in place of the condensed object “DIR1-DIR3” (see FIG. 3e).

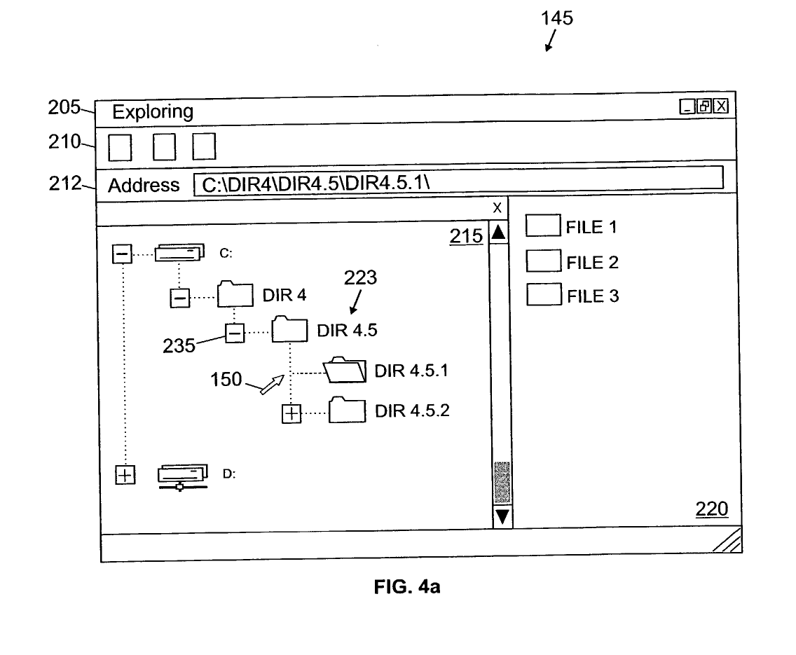

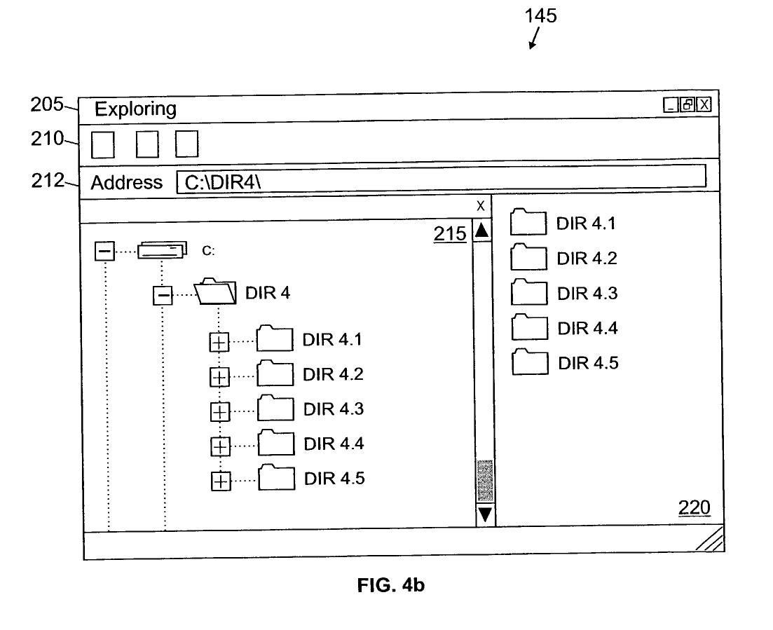

Considering now FIG. 4a, a further embodiment of the present invention corresponding to the hidden option (of the pop-up menu) is shown. In this case, whenever a node is selected and expanded all the objects interposed between the one representing the selected node and the one representing its parent node disappear. In the example shown in the figure (path “C:\DIR4\DIR4.5\DIR4.5.1\FILE3”), the objets representing the sub-directories “DIR1”, “DIR2” and “DIR3” are hidden (moving the object “DIR4” close to the object “C:”), and the objects representing the sub-directories “DIR4.1”, “DIR4.2”, “DIR4.3” and “DIR4.4” are hidden (moving the object “DIR4.5” close to the object “DIR4”).

If the user selects and collapses an expanded object 223 (by clicking on the respective expansion box 235), the objects representing the corresponding child nodes disappear; at the same time, the objects interposed between the collapsed object and the object representing the corresponding parent node are restored. For example, if the user collapses the object “DIR4.5”, the objects “DIR4.1”, “DIR4.2”, “DIR4.3” and “DIR4.4” are displayed again (see FIG. 4b).

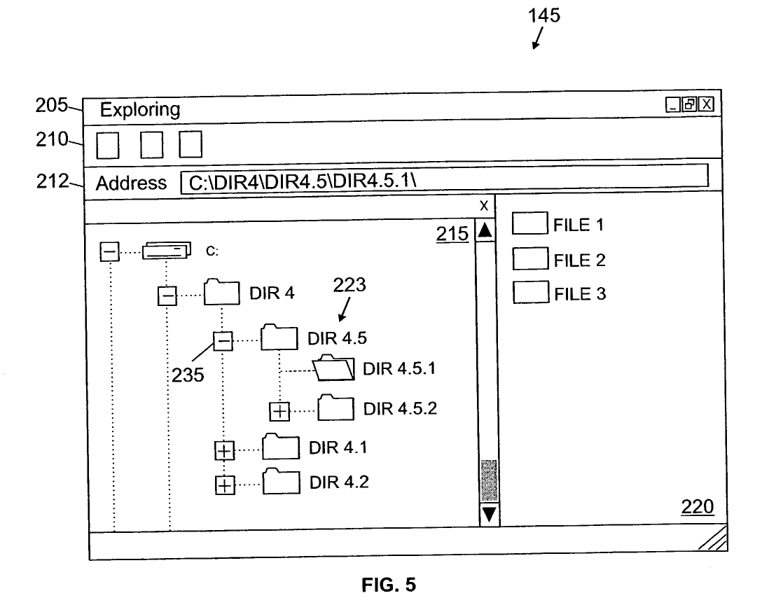

Alternatively, a still further embodiment of the present invention corresponding to the ordered option (of the pop-up menu) is shown in FIG. 5. In this case, whenever a node is selected and expanded all the objects representing its sibling nodes are rearranged moving the object representing the selected node (together with the objects representing its child nodes) close to the object representing its parent node. In the example shown in the figure (path “C:\DIR4\DIR4.5\DIR4.5.1\FILE3”), the objects representing the sub-directories “DIR1”, “DIR2” and “DIR3” are moved below the object “DIR4”, and the objects representing the sub-directories “DIR4.1”, “DIR4.2”, “DIR4.3” and “DIR4.4” are moved below the object “DIR4.5”.

If the user selects and collapses an expanded object 223 (by clicking on the respective expansion box 235), the original sequence of the corresponding sibling nodes is restored. For example, if the user collapses the object “DIR4.5”, the objects “DIR4.1”, “DIR4.2”, “DIR4.3” and “DIR4.4” are moved again close to the object “DIR4” (returning to the representation shown in FIG. 4b).

Similar considerations apply if a different visual representation of the file system is provided, if equivalent graphical objects are supported, if a different procedure is envisaged for setting the mode of operation of the exploring window (for example, using a pull-down menu), and the like. Alternatively, an equivalent visual cue (instead of the crossed folder) is provided for identifying the condensed objects, the common label consists of a different string (such as the generic word “other”), the list of the names identifying the nodes associated with the condensed object is displayed in another way, a specific command is supported for restoring the objects that have been condensed, for restoring the hidden objects or for restoring the original sequence (for example, double-clicking on a blank area of the exploring window or using a dedicated button of the menu).

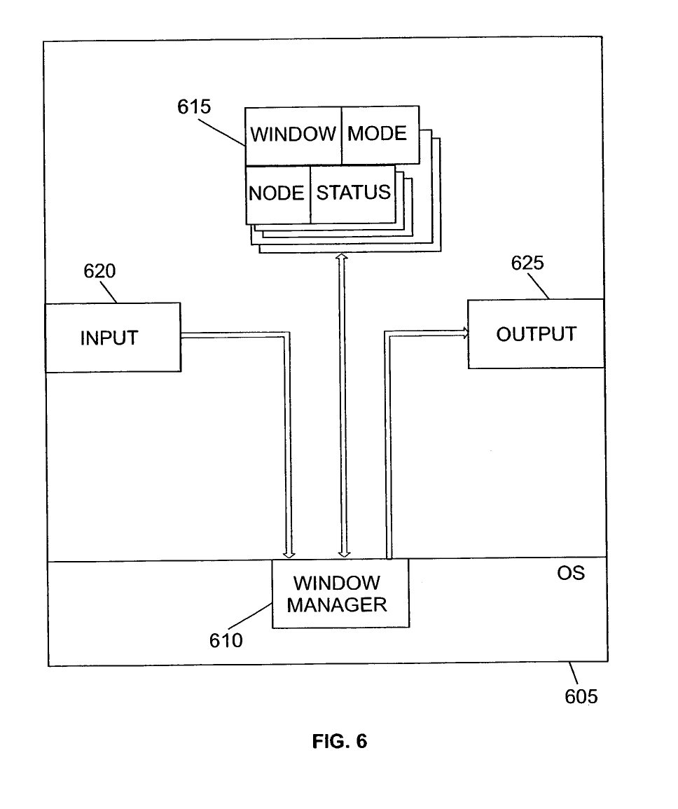

Considering now FIG. 6, a partial content of the working memory of the computer in operation is shown; the information (programs and data) is typically stored on the hard-disk and loaded (at least partially) into the working memory when the programs are running. The programs are initially installed onto the hard disk from CD-ROM.

The graphical user interface of the computer is generally part of an operating system (OS) 605 providing a collection of utility programs for controlling the computer. Particularly, the operating system 605 includes a window manager 610, which is responsible for managing the graphical objects that a user views during operation of the computer. The window manager 610 controls a series of objects 615, each one representing an instance of the exploring window used for navigating the file system. The window object 615 includes attributes defining the characteristics of the exploring window (such as its position and size); a further attribute is used to store the current mode of operation of the exploring window (standard, condensed, hidden or ordered). For each node of the file system, a corresponding object defines its description (for example, the name, a pointer to the parent node, a pointer to the first sibling node) and its status (for example, if the node is selected, if the corresponding object is expanded, condensed or hidden).

An input interface 620 is used to enter data and/or commands with the keyboard or the mouse. The input interface generates and sends corresponding display requests to the window manager 610; the window manager 610 in turn interfaces directly with a screen buffer 625 (which content is then provided to the monitor).

Similar considerations apply if the graphical user interface includes different modules, if the exploring window is defined with an equivalent data structure, if each window object stores additional information, and the like.

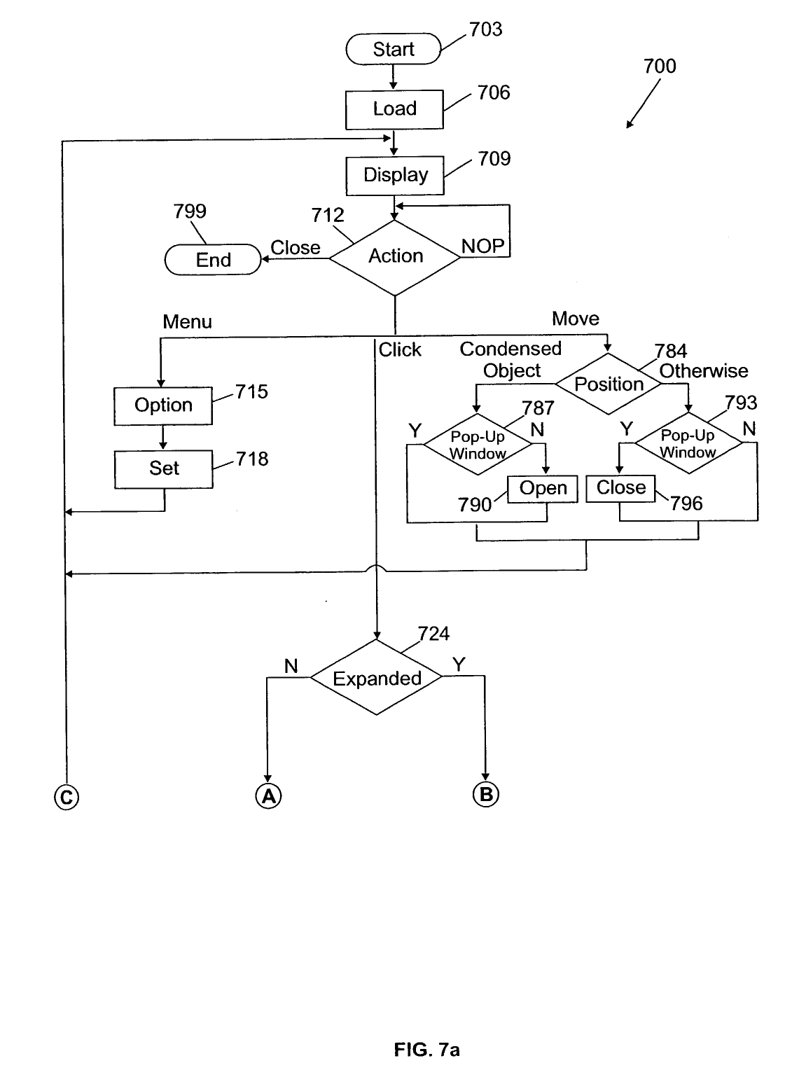

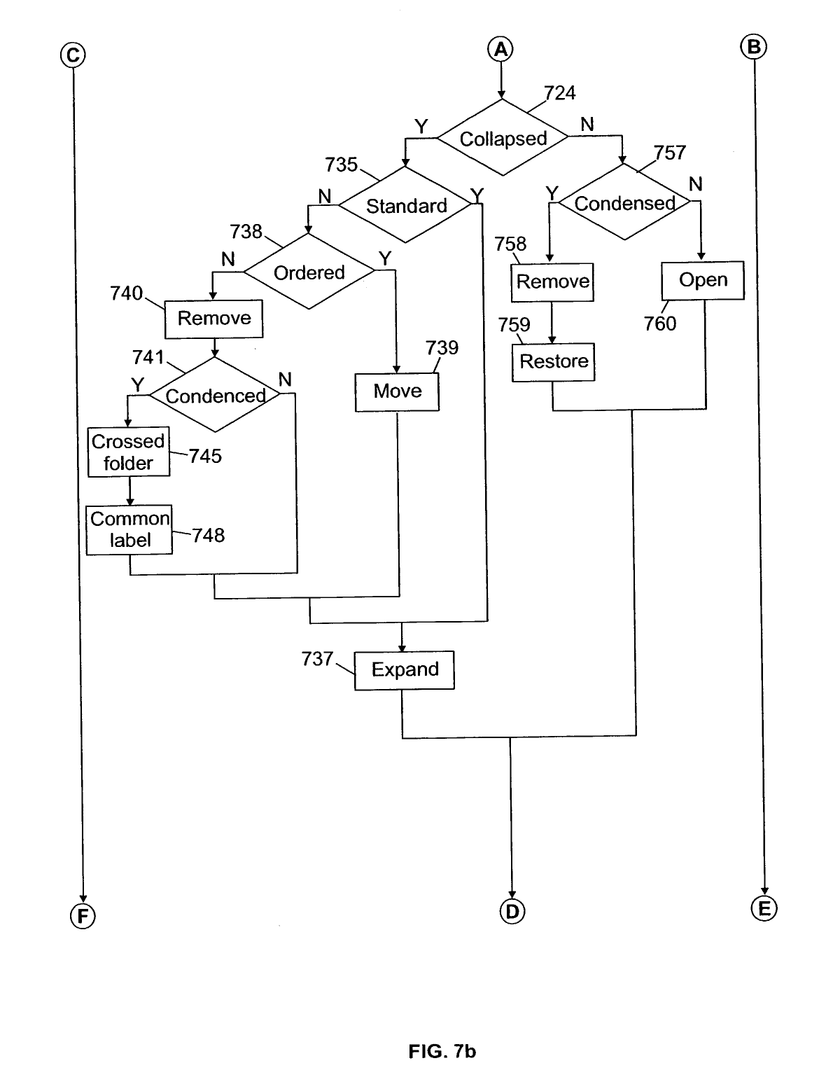

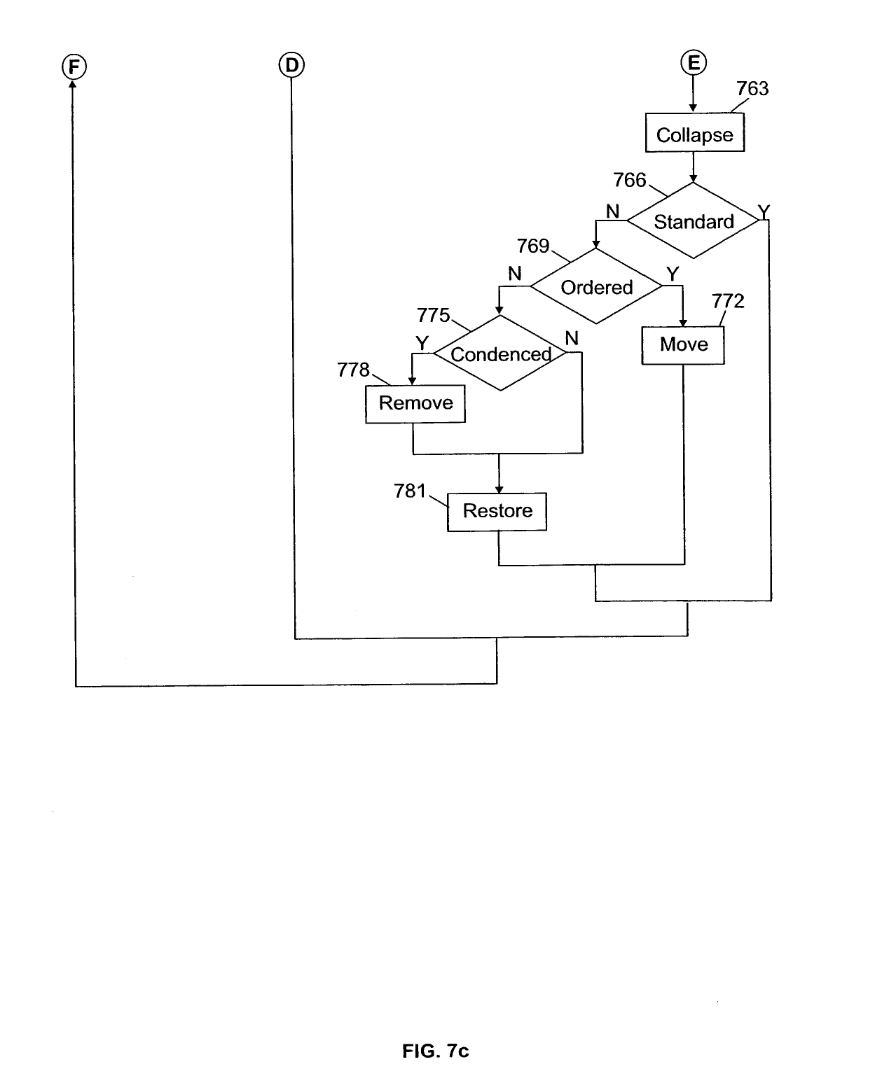

With reference now to FIGS. 7a-7c, whenever an exploring window for navigating the file system is opened the window manager performs a method 700 (it should be noted that the method is described with a flow chart for the sake of simplicity, although the window manager typically operates according to the object-oriented paradigm). The method starts at block 703 and then passes to block 706, wherein information about the file system is loaded from the hard-disk. The exploring window is created (instantiating a corresponding window object) and displayed on the monitor at step 709; particularly, the stylized element (with the possible expansion box) and the label associated with each node fitting in the respective frame of the exploring window are shown.

The method then enters an idle loop at block 712, waiting for an action on the part of the user. If the user opens the pop-up menu the blocks 715-718 are executed, whereas if the user clicks on an object the blocks 724-781 are executed; on the other hand, if the user moves the mouse (without clicking any button) the blocks 784-796 are executed. In every case, the method then returns to block 709 for refreshing the exploring window on the monitor. Conversely, when the user closes the exploring window the method ends at the final block 799.

Considering now block 715 (pop-up menu), the user selects one of the options defining the mode of operation of the exploring window (standard, condensed, hidden or ordered); the respective attribute of the window object is updated in memory accordingly. Proceeding to block 718, the attributes defining the status of each node (selected, expanded, condensed or hidden) are changed so as to reflect the new mode of operation of the exploring window (for example, the condensed or hidden attributes are reset when the mode of operation is switched to standard); the method then returns to block 709 for refreshing the exploring window (with the result of displaying the visual representation of the file system according to the new mode of operation of the exploring window).

With reference to block 724 (click), the method verifies whether the selected object represents an expanded directory. If not, the method passes to block 734 wherein a test is made to determine whether the selected object represents a collapsed directory. If so, the mode of operation of the exploring window is checked at block 735.

If the mode of operation of the exploring window is standard, the method descends into block 737 (described in the following). On the contrary, a test is made again on the mode of operation of the exploring window a block 738. If the mode of operation is ordered, the method passes to block 739 wherein the objects representing the sibling nodes of the selected node are rearranged moving the object representing the selected node close to the object representing its parent node; the method then descends into block 737. On the contrary (mode of operation condensed or hidden), the objects interposed between the object representing the selected node and the object representing its parent node are removed at block 740. The method then enters decision block 741. If the mode of operation is hidden, the method descends into block 737 directly. On the contrary, if the mode of operation is condensed the method passes to block 745, wherein the removed objects are replaced with a condensed object (including a crossed folder and an expansion box filled with the sign “+”) the respective common label is created at block 748, by combining the name of the first node and the name of the last node associated with the removed objects. The method then continues to block 737.

With reference now to block 737, the selected object is expanded displaying the objects representing the corresponding child nodes; the method then returns to block 709.

Referring back to block 734, if the selected object does not represent a collapsed directory a test is made at decision block 757 to determine whether the selected object is condensed. If so, the method descends into block 758, wherein the condensed object is removed; continuing to block 759, the objects representing the corresponding nodes are restored. Conversely (that is, the selected node is a leaf of the tree), the method passes to block 760; the application associated with the selected node (if a file and not an empty directory) is started (for example, the file is opened or a corresponding program is executed). In both cases, the method then returns to block 709.

With reference again to block 724, if the selected object represents an expanded directory the selected object is collapsed at block 763 removing the objects representing the corresponding child nodes. Continuing to block 766, the mode of operation of the exploring window is checked. If the mode of operation of the exploring window is standard, the method returns to block 709 directly. On the contrary, a test is made again on the mode of operation of the exploring window at block 769. If the mode of operation is ordered, the method passes to block 772, wherein the sibling nodes of the selected one are restored to their original sequence; the method then returns to block 709. On the contrary (mode of operation condensed or hidden), the method continues to decision block 775. If the mode of operation is condensed, the condensed object associated with the sibling nodes of the selected one is removed at block 778; the method then proceeds to block 781 (described in the following). On the contrary, if the mode of operation is hidden the method descends into block 781 directly. Considering now block 781, the (condensed or hidden) objects representing the sibling nodes of the selected one are restored; the method then returns to block 709.

Moving to block 784 (mouse movement), the new position of the mouse is checked. If the mouse points to a condensed object, the method verifies at block 787 whether the corresponding pop-up window (listing the names of the nodes associated with the condensed object) is displayed. If not, the pop-up window is opened at block 790 (close to the pointer); the method then returns to block 709. Conversely, the method returns to block 709 directly.

Referring back to block 784, if the pointer is not placed over a condensed object, the method verifies at block 793 whether a pop-up window listing the names of the nodes associated with a condensed object is displayed. If so, the pop-up window is closed at block 796; the method then returns to block 709. Conversely, the method returns to block 709 directly.

Similar considerations apply if an equivalent method is performed, if the graphical user interface supports a different number of modes of operation (down to a single one), if the objects interposed between the one representing the selected node and the one representing its parent node are condensed, hidden or reordered when the node is selected with a double-click of the mouse, and the like.

More generally, the present invention proposes a method of navigating a hierarchical structure in a data processing system; the hierarchical structure has a plurality of nodes. The method starts with the step of displaying a visual representation of the hierarchical structure (or a part thereof); the visual representation includes a tree of graphical objects each one representing a node. A graphical object representing a selected node among a plurality of sibling nodes dependent on a common parent node is selected; the selected node has one or more child nodes dependent thereon. The selected graphical object is expanded by displaying the graphical objects representing the child nodes. In the method of the invention, the visual representation is updated to have at most one graphical object interposed between the expanded graphical object and the graphical object representing the parent node.

The method of the invention generates a visual representation of the hierarchical structure that is concise and ensures a good overview of the structure.

Moreover, the devised solution provides an enhanced perception of the hierarchical structure, and particularly of the path from the root node to the target node.

This method facilitates a simple and clear navigation within the hierarchical structure; as a consequence, several operations can be performed on the hierarchical structure in a very fast manner.

The system according to the present invention is particularly advantageous when the hierarchical structure is large, even if different applications are not excluded.

The preferred embodiment of the invention described above offers further advantages.

For example, all the objects interposed between the object representing the selected node and the object representing its parent node are condensed into a single object.

In this way, the user is always aware of the existence of the nodes associated with the condensed object (even if the corresponding objects are not displayed).

Preferably, a crossed folder (or another visual cue) is associated with the condensed object.

The proposed feature makes it very easy to detect any condensed object.

As a further improvement, a common label indicative of the corresponding nodes is associated with the condensed object.

This representation improves the perception of the nodes associated with the condensed object.

Advantageously, when the user points to the condensed object the names of the associated nodes are displayed.

As a consequence, the objects replaced by the expanded object can be identified in a very simple manner (without having to restore them).

Moreover, whenever the user collapses an expanded object, the objects associated with the corresponding condensed object are restored.

In this way, the objects removed when navigating the hierarchical structure are automatically displayed as soon as they are necessary.

As a further improvement, whenever the condensed object is selected the corresponding objects are restored.

This feature provides a simple way of returning to the standard representation of the hierarchical structure.

Alternatively, the condensed object is represented without any visual cue, no common label is provided, the method does not support any option for displaying the names identifying the nodes associated with the condensed object, the objects corresponding to a condensed object are not restored automatically, or the condensed object cannot be selected for restoring the corresponding objects.

In a different embodiment of the invention, the objects interposed between the object representing the selected node and the object representing its parent node are hidden.

The devised solution provides a very concise overview of the hierarchical structure.

Moreover, whenever the user collapses an expanded object, the corresponding hidden objects are restored.

In this way, the hidden objects are automatically displayed when necessary.

In another embodiment of the invention, the object representing the selected node is moved close to the object representing its parent node (rearranging the objects representing its sibling nodes).

This feature provides all the advantages of the devised solution, but at the same time it maintains the complete representation of the hierarchical structure without removing any object.

Moreover, whenever the user collapses an expanded object, the original sequence of the objects representing the corresponding sibling nodes is restored.

In this way, the user may return to the standard representation of the hierarchical structure in a very simple manner.

However, the devised solution leads itself to be implemented with different representations of the hierarchical structures, and even without any support for automatically restoring the hidden objects or the original sequence when the corresponding expanded object is collapsed.

Advantageously, the solution according to the present invention is implemented with a computer program, which is provided on CD-ROM.

Typically, the program code for performing the method of the invention is part of the graphical user interface of the computer.

Alternatively, the program is provided on floppy-disk, is pre-loaded onto the hard-disk, or is stored on any other computer readable medium, is sent to the computer through a network (typically the INTERNET), is broadcast, or more generally is provided in any other form directly loadable into a working memory of the computer. However, the method according to the present invention leads itself to be carried out with an application specifically designed for this purpose, or even with a hardware structure (for example, integrated in a chip of semiconductor material).

Naturally, in order to satisfy local and specific requirements, a person skilled in the art may apply to the solution described above many modifications and alterations all of which, however, are included within the scope of protection of the invention as defined by the following claims.

1. A method (700) of navigating a hierarchical structure in a data processing system, the hierarchical structure having a plurality of nodes, wherein the method includes the steps of:
displaying (706-709) a visual representation of at least part of the hierarchical structure, the visual representation including a tree of graphical objects each one representing a node,
selecting (712) a graphical object representing a selected node among a plurality of sibling nodes dependent on a common parent node, the selected node having at least one child node dependent thereon,
expanding (737) the selected graphical object by displaying the graphical objects representing the at least one child node,
characterized by the step of
updating (735-748) the visual representation to have at most one graphical object interposed between the expanded graphical object and the graphical object representing the parent node.

2. The method (700) according to claim 1, wherein the step of updating (735-748) the visual representation includes condensing (740-748) the graphical objects interposed between the expanded graphical object and the graphical object representing the parent node into a single condensed graphical object.

3. The method (700) according to claim 2, wherein the step of updating (735-748) the visual representation further includes associating (745) a visual cue to the condensed graphical object.

4. The method (700) according to claim 2 or 3, wherein a label is visually associated with each graphical object, the label being indicative of the node represented by the graphical object, and wherein the step of updating (735-748) the visual representation further includes visually associating (748) the condensed graphical object with a further label indicative of the nodes corresponding to the condensed graphical object.

5. The method (700) according to claim 4, further including the steps of:
pointing (784) to the condensed graphical object, and
displaying (790) the labels associated with the graphical objects corresponding to the condensed graphical object.

6. The method (700) according to any claim from 2 to 5, further including the steps of:
collapsing (763) the expanded graphical object by removing the graphical objects representing the at least one child node,
removing (778) the condensed graphical object, and
restoring (781) the graphical objects interposed between the collapsed graphical object and the graphical object representing the parent node.

7. The method (700) according to any claim from 2 to 6, further including the steps of:
selecting (712) the condensed graphical object,
removing (758) the condensed graphical object, and
restoring (759) the graphical objects interposed between the expanded graphical object and the graphical object representing the parent node.

8. The method (700) according to claim 1, wherein the step of updating (735-748) the visual representation includes hiding (740) the graphical objects interposed between the expanded graphical object and the graphical object representing the parent node.

9. The method (700) according to claim 8, further including the steps of:
collapsing (763) the expanded graphical object by removing the graphical objects representing the at least one child node, and
restoring (781) the graphical objects interposed between the collapsed graphical object and the graphical object representing the parent node.

10. The method (700) according to claim 1, wherein the graphical objects representing the sibling nodes are ordered in an original sequence starting from a first position adjoining the graphical object representing the parent node, the step of updating (735-748) the visual representation including rearranging (739) the graphical objects representing the sibling nodes by moving the expanded graphical object to the first position.

11. The method (700) according to claim 10, further including the steps of:
collapsing (763) the expanded graphical object by removing the graphical objects representing the at least one child node, and
restoring (772) the original sequence.

12. A computer program (610) directly loadable into a working memory of a data processing system (100) for performing the method of any claim from 1 to 11 when the program is run on the data processing system.

13. A program product (110) comprising a computer readable medium on which the program (610) of claim 12 is stored.

14. A graphical user interface (605) of a data processing system (100) including program code (610) for performing the method of any claim from 1 to 11 when the program code is run on the data processing system.

15. A data processing system (100) for navigating a hierarchical structure, the hierarchical structure having a plurality of nodes, wherein the system includes means (115, 625) for displaying a visual representation of at least part of the hierarchical structure, the visual representation including a tree of graphical objects each one representing a node, means (125, 620) for selecting a graphical object representing a selected node among a plurality of sibling nodes dependent on a common parent node, the selected node having at least one child node dependent thereon, means (610) for expanding the selected graphical object by displaying the graphical objects representing the at least one child node,
characterized in that
the system further includes means (610) for updating the visual representation to have at most one graphical object interposed between the expanded graphical object and the graphical object representing the parent node.
